(19) United States
(12) Patent Application Publication
(10) Pub. No.: US 2002/0093162 A1
(43) Pub. Date: Jul. 18, 2002

(54) Foldable scooter step board

(76) Inventor: Chin-Hsing Tai, Taichung (TW)

Correspondence Address: Raymond Y. Chan, 1050 Oakdale Ave., Arcadia, CA, 91006, US

(21) Appl. No.: 09/760,554

(22) Filed: Jan. 17, 2001

(51) Int. Cl. B62M 1/00

(52) U.S. Cl. 280/87.041

(57) ABSTRACT

A foldable scooter step board includes a board body and a pair of supporting walls. The board body has a predetermined size for supporting a user standing thereon, wherein a wheel chamber is integrally provided at a tail portion of the board body for rotatably mounting a rear wheel. The pair of supporting walls are integrally protruded underneath the board body for rigidly supporting the board body. Therefore, the board body with the supporting walls is integrally formed in one piece such that the step board is capable of more evenly distributing and supporting a downward force and stress applied by the user's weight.

### BACKGROUND OF THE PRESENT INVENTION

1. Field of Invention

The present invention relates to a scooter, and more particularly to a foldable scooter step board which is integrally formed in one piece to rigidly support and evenly distribute a downward force on the step board. Thus, the foldable scooter step board has a rear wheel chamber integrally provided on a tail portion of the step board for supportively receiving a rear wheel so as to minimize a stress around the tail portion of the step board.

2. Description of Related Arts

A conventional scooter comprises a step board, a steering assembly foldably mounted on a front portion of the step board wherein a front wheel rotatably attached to a bottom end of the steering assembly, and a rear wheel rotatably mounted on a rear portion of the step board. In order to rotatably mount the rear wheel on the step board, a pair of parallel extending arms are welded to the rear portion of the step board in such a manner that the rear wheel is rotatably mounted between the two extending arms.

However, there are some major drawbacks of such conventional scooter. First, while riding the scooter, the user's weight and a vibration force are applied directly on and distribute to the step board and the rear wheel that causes stress to the weld joint between the extending arms and step board. It may render the extending arms to be bent, or worse, wrecked, as such forces are applied to the step board as the user riding on the scooter. So, such weak structural design of the scooter may cause unwanted injury to the user, especially the soft and weak child.

Second, when the user stands on the step board, the step board should be rigid enough to support the weight of the user. Therefore, the scooter further comprises a supportive bar welded underneath the step board for rigidly supporting the step board. However, such weld connection may not provide a strong and rigid structure to the step board in order to support a predetermined weight that the scooter is supposed to sustain. So, the step board will be permanently bent or broken over a period time of use. Since the step board cannot be repaired, once the step board is wrecked, the user must purchase a new one, which is a waste of source.

Third, since the parts of the scooter are respectively welded to the step board, the manufacturing process may merely produce the scooter piece by piece. So, the manufacturing process will be more complicated since each part of the scooter must be welded to the step board individually. Also, the material cost of the scooter will be highly increase since the scooter requires lots of welding material in order to joint the parts to the step board to provide a rigid structure of the scooter.

### SUMMARY OF THE PRESENT INVENTION

A main object of the present invention is to provide a foldable scooter step board which is integrally formed in one piece to rigidly support and evenly distribute a downward force on the step board.

Another object of the present invention is to provide a foldable scooter step board defining a rear wheel chamber integrally provided on a tail portion of the step board for supportively receiving a rear wheel that minimizes a stress around the tail portion of the step board.

Another object of the present invention is to provide a foldable scooter step board, which is adapted for incorporating with a brake arrangement that can provide a quick response of the braking action for the stroller.

Another object of the present invention is to provide a foldable scooter step board, which requires no alternation to the original structural design of the scooter, so as to minimize the manufacturing cost of incorporating the step board with the scooter.

Accordingly, in order to accomplish the above objects, the present invention provides a foldable scooter step board, which comprises:

a board body, which has a predetermined size for supporting a user standing thereon, having a head portion for foldably connecting a steering assembly thereto and a tail portion; and

a pair of supporting walls for rigidly supporting the board body, which are integrally and parallelly protruded downwardly form a bottom side of the board body so as to form a longitudinal groove between the two supporting walls and extending from the head portion to the tail portion of the board body;

wherein a tail slot is formed on the tail portion of the board body, wherein a width of the tail slot equal to or smaller than a distance between the two supporting walls, so that the tail slot and two end portions of the two supporting walls integrally form a wheel chamber adapted for rotatably mounting a rear wheel.

### BRIEF DESCRIPTION OF THE DRAWINGS

FIG. 1 is a perspective view of a conventional scooter.

FIG. 2 is a top perspective view of a foldable scooter step board according to a preferred embodiment of the present invention.

FIG. 3 bottom perspective view of the foldable scooter step board according to the above preferred embodiment of the present invention.

FIG. 4 illustrates a manufacturing process of the foldable scooter step board according to the above preferred embodiment of the present invention.

FIG. 5 is a perspective view of the foldable scooter step board according to the above preferred embodiment of the present invention.

FIG. 6 is a side view of the tail position of the foldable scooter step board according to the above preferred embodiment of the present invention.

FIG. 7 is a side sectional view of the conventional scooter.

### DETAILED DESCRIPTION OF THE PREFERRED EMBODIMENT

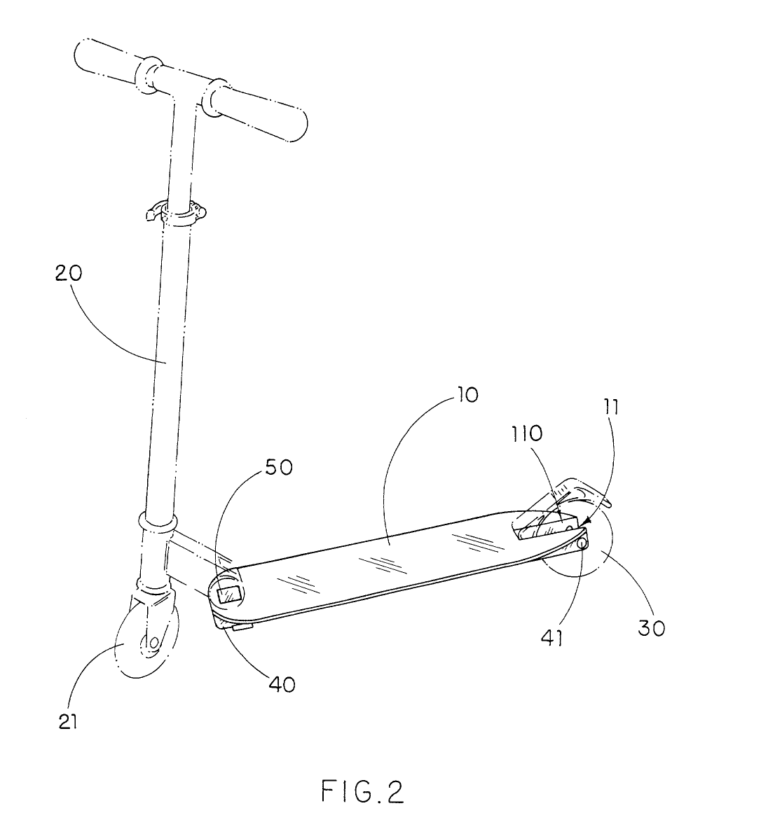

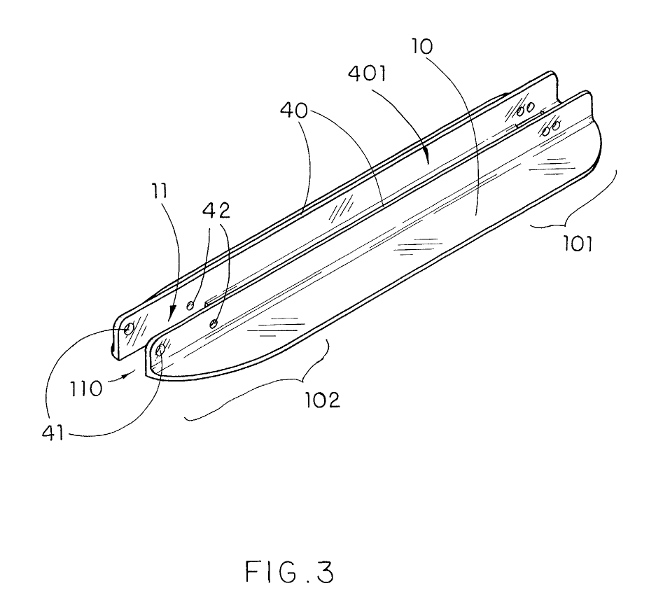

Referring to FIGS. 2 and 3 of the drawings, a foldable scooter step board according to a preferred embodiment of the present invention is illustrated, wherein the step board is adapted for incorporating with every conventional scooter.

As shown in FIGS. 2 and 3, the foldable scooter step board comprises provides a foldable scooter step board, which comprises a board body 10 and a pair of supporting walls 40 for rigidly supporting the board body 10.

The board body 10, which has a predetermined size for supporting a user standing thereon, has a head portion 101 for foldably connecting a steering assembly 20 thereto and a tail portion 102.

The pair of supporting walls 40 are integrally and parallelly protruded downwardly form a bottom side of the board body 10 so as to form a longitudinal groove 401 between the two supporting walls 40 and extending from the head portion 101 to the tail portion 102 of the board body 10.

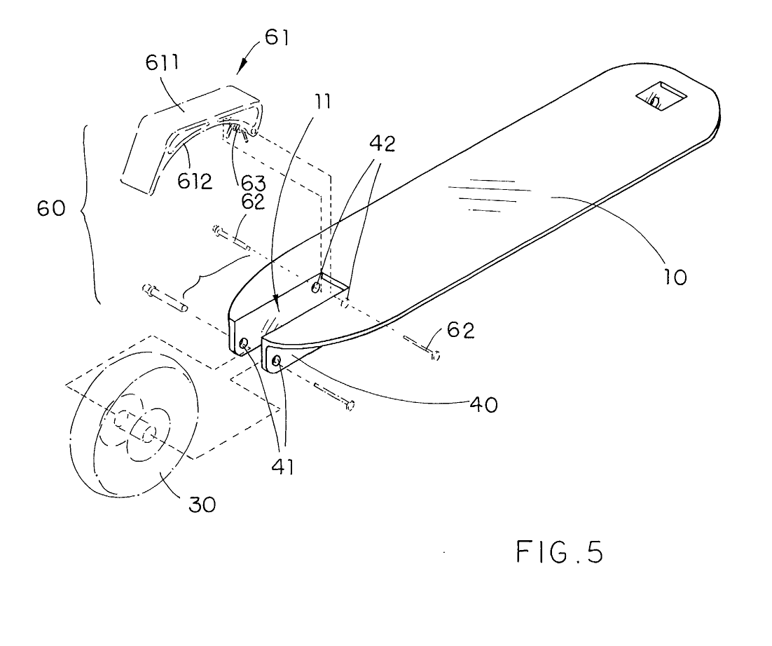

As shown in FIGS. 2 and 5, a tail slot 110 is formed on the tail portion 102 of the board body 10, wherein a width of the tail slot 11 equal to or smaller than a distance between the two supporting walls 40, i.e. the width of the groove 401, so that the tail slot 110 and two end portions of the two supporting walls 40 integrally form a wheel chamber 11 adapted for rotatably mounting a rear wheel 3 0.

According to the preferred embodiment, the board body 10 is preferably made of durable but light material such as aluminum adapted for rigidly supporting a downward force, i.e. the user′ weight, applied on the board body 10.

The board body 10 of the present invention, such as a standard scooter step board, comprises a foldable joint 50 for foldably connecting the steering assembly 20 at the head portion 101 of the board body 10, wherein the steering assembly 20 comprises a front wheel 21 rotatably attached thereto in such a manner that the steering assembly 20 is adapted for steering the scooter.

The pair of parallel supporting walls 40 is longitudinally and downwardly extended from a bottom side of the board body 10 so as to substantially increase a rigid structure of the board body 10 of the foldable scooter step board 10. In other words, the supporting walls 40 are adapted for providing a rigid structure to the board body 10 to support the downward force applied thereon such that the board body 10 is capable of supporting more weight in comparison with the conventional scooter step board having same frame structure and size.

In order to well support the rear wheel 30 and construct the board body 10, each rear portion of the supporting walls 40 has a wheel hole 41 formed thereon, as shown in FIG. 3, in such a manner that a wheel shaft 31 of the rear wheel 30 can be rotatably inserted through the wheel holes 41 of the supporting walls 40. So, when the user is riding on the scooter, the stress created by a vibration force between the ground and the rear wheel 30 can evenly be distributed on the two integrally formed supporting walls 40 and the board body 10 that can prevent the breaking the pair of parallel extending arms welded to the rear portion of the conventional step board.

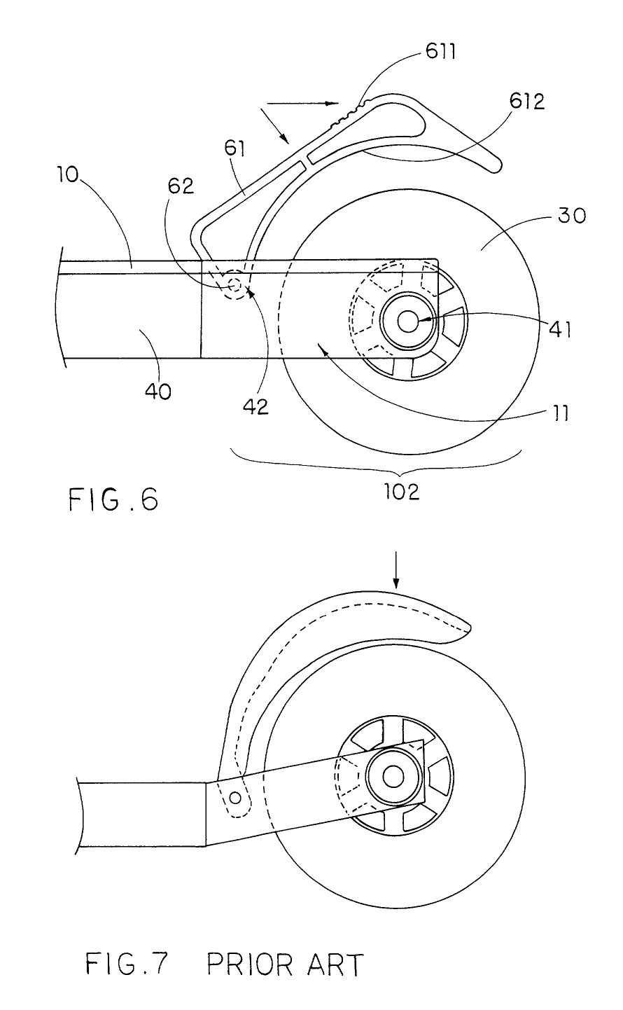

Referring to FIGS. 5 to 6, the foldable stroller step board is adapted for incorporating with a foot brake arrangement 60 so as to provide a quick response of the braking action of the stroller.

The foot brake arrangement 60 comprises a brake unit 61, a pivot axle 62 and a spring element 63. The brake unit 61 is pivotally connected to the tail portion 102 of the board body 10 in a radially movable manner. The brake unit 61 has a L-shaped outer inclined panel 611 for operating the brake unit 61 and a curved inner brake unit 612 for frictionally biasing against the rear wheel 30 to stop the rotation of the rear wheel 30. In other words, when a downward force is applied on the outer inclined panel 611 of the brake unit 61, the curved inner brake unit 612 of the brake unit 61 is arranged to be driven downwardly to frictionally bias against an outer surface of the rear wheel 30 so as to reduce the speed of, or stop, the rotation of the rear wheel 30.

The pivot axle 62 comprises a pair of brake axles mounted between two brake supporting holes 42 formed on the two rear portions of the two supporting walls respectively so as to pivotally mount a front end of the brake unit 61 between the two supporting walls 40. The spring element 63, which is mounted on the pivot axle 62, has one end extended to bias against the step board 10 and another end extended to bias against the brake unit 61, so as to normally support the brake unit 61 to extend right above the rear wheel 30. Therefore, the user may simply step on the outer inclined panel 611 of the brake unit 61 so as to press the inner brake unit 612 against the rear wheel 30 to stop the rotation of the rear wheel 30.

Comparing with a convention brake arrangement of the scooter as shown in FIG. 6, the convention brake arrangement simply comprises a single curved brake panel pivotally connected between the extending arms welded to the conventional step board. The disadvantages of the conventional brake arrangement is that the supporting holes must be formed at a middle of the extending arms in order to rigidly support the brake panel, which may affect the radial movement of the brake panel. So, the radial movement of the brake plane is limited by the structure of the step board. Thus, in order to effectively operate the brake arrangement, the user must step on the highest point of the brake panel to press an inner surface of the brake panel frictionally against the rear wheel, i.e. the user must raise his or her leg to finish the braking operation.

However, the brake arrangement 60 of the present invention is adapted for not only raising up the brake axis in a higher position to improve the radial movement of the brake unit 61 but also providing a better brake operation direction of the brake unit 61 for effectively operate the brake arrangement 60 since the user is able to step on the outer inclined panel 611 of the brake unit 61 without lifting up his or her leg. Thus, since the brake supporting holes 42 are formed on the supporting walls 40, the brake unit 61 can be rigidly supported on the supporting walls 40 too. In other words, a braking force generated from the friction between the rear wheel 30 and the brake unit 61 can be evenly distributed on the board body 10 so as to prevent the board body 10 from being wrecked and enhance the stabilization of the scooter.

It is worth to mention that since the board body 10 with the supporting walls 40 is integrally formed in one piece, no welding connection is needed to joint the board body 10 such that the board body 10 is capable of more evenly distributing and supporting the downward force and stress applied by the user's weight.

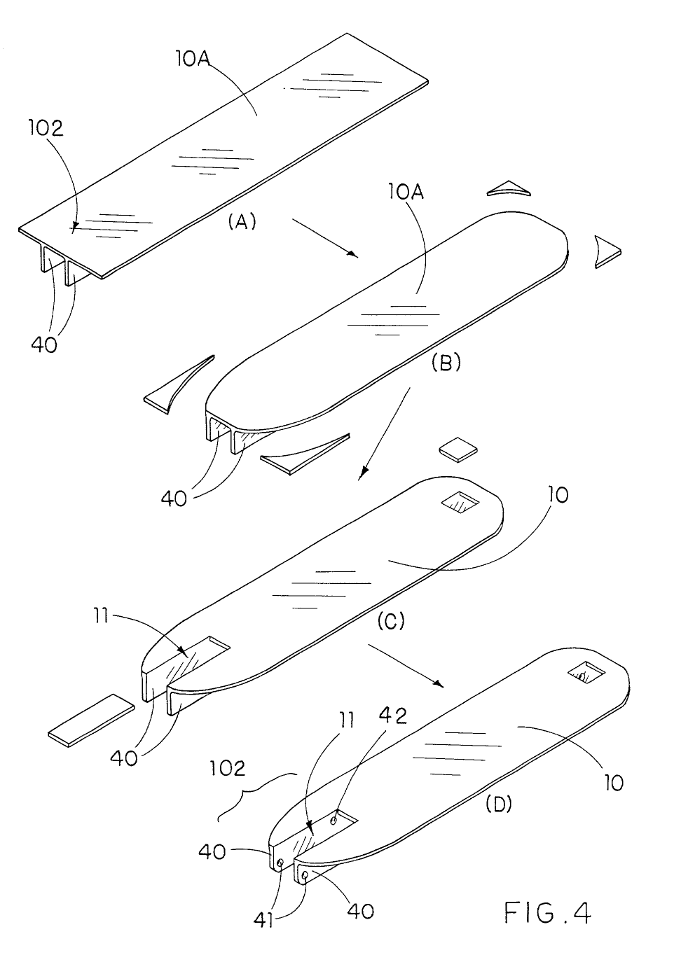

Referring to FIG. 4, a process of manufacturing the foldable scooter step board 10 is illustrated, which comprises the steps of:

(a) forming a step board panel 10A by cutting a predetermined length of an elongated π-shaped board which is made by extrusion to comprise a top panel 10A and two parallel supporting walls 40 integrally and downwardly extended from a bottom side of the top panel longitudinally;

(b) trimming the step board panel 10A into a predetermined shaped, wherein four comers of the top panel 10A are curvedly cut to form a board body 10;

(c) forming a tail slot by cutting out the material of a tail portion between the two supporting walls 40 so as to form a wheel chamber 11 between the two supporting walls 40 at the tail portion of the step board panel 10A; and

(d) forming a pair of wheel holes 41 at two ends of the two supporting walls 40 respectively for rotatably mounting a rear wheel 30.

For incorporating the foldable scooter step board with the brake arrangement 60, after the step (d), further comprises the steps of:

(e-1) forming two brake supporting holes 42 on the two supporting walls within the wheel chamber 11 respectively; and

(e-2) pivotally mounting a front end of a brake unit 61 between the two brake supporting holes 42 provided on the tail portion 102 of the board body 10 for braking the rotation speed of the rear wheel 30.

Also, the manufacturing process of the foldable scooter step board of the present invention is simplified since no further welding process of the conventional step board is needed and thus the manufacturing cost of the present invention can be reduced.

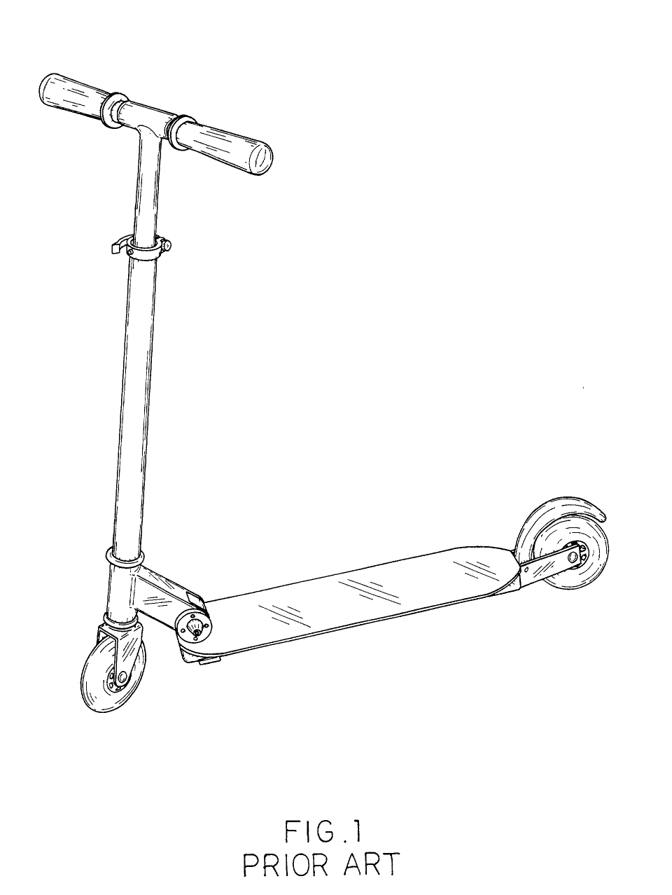

According to the preferred embodiment of the present invention disclosed above, when the user rides on the scooter, the user's weight applies downward force will be more evenly distributed on the entire board body 10. Due to the fact that the board body 10 of the present invention integrally provides the wheel chamber 11 at the tail portion thereof instead of welding two extending arms to the step board of the conventional scooter as shown in FIG. 1, so that the foldable scooter step board of the present invention is more durable and stable.

What is claimed is:

1. A foldable scooter step board, comprising:
a board body having a tail portion and a head portion for foldably connecting a steering assembly thereto; and
a pair of supporting walls integrally and parallelly protruded downwardly form a bottom side of said board body so as to form a longitudinal groove between said two supporting walls and extending from said head portion to said tail portion of said board body, wherein a tail slot is formed on said tail portion of said board body and positioned between said two supporting walls, wherein said tail slot and two end portions of said two supporting walls integrally form a wheel chamber adapted for rotatably mounting a rear wheel.

2. The foldable scooter step board, as recited in claim 1, wherein a width of said tail slot equal to a distance between said two supporting walls.

3. The foldable scooter step board, as recited in claim 1, wherein each of said rear portions of said supporting walls has a wheel hole formed thereon adapted for inserting a wheel shaft therethrough for rotatably mounting said rear wheel thereon.

4. The foldable scooter step board, as recited in claim 2, wherein each of said rear portions of said supporting walls has a wheel hole formed thereon adapted for inserting a wheel shaft therethrough for rotatably mounting said rear wheel thereon.

5. The foldable scooter step board, as recited in claim 1, wherein each of said rear portions of said supporting walls has a brake supporting hole positioned adjacent to a front end of said wheel chamber.

6. The foldable scooter step board, as recited in claim 2, wherein each of said rear portions of said supporting walls has a brake supporting hole positioned adjacent to a front end of said wheel chamber.

7. The foldable scooter step board, as recited in claim 3, wherein each of said rear portions of said supporting walls has a brake supporting hole positioned adjacent to a front end of said wheel chamber.

8. The foldable scooter step board, as recited in claim 4, wherein each of said rear portions of said supporting walls has a brake supporting hole positioned adjacent to a front end of said wheel chamber.

9. The foldable scooter step board, as recited in claim 5, further comprising a foot brake arrangement which comprises a brake unit, a pivot axle and a spring element, wherein said brake unit includes a L-shaped outer inclined panel for operating said brake unit and a curved inner brake unit having two ends integrally connected with two ends of said outer inclined panel for frictionally biasing against said rear wheel to stop a rotation of said rear wheel, said pivot axle being mounted between said two brake supporting holes formed on said two rear portions of said supporting walls respectively so as to pivotally mount a front end of said brake unit between said two supporting walls, wherein said spring element, which is mounted on said pivot axle, has one end extended to bias against said step board and another end extended to bias against said brake unit, so as to normally support said brake unit to extend right above said rear wheel.

10. The foldable scooter step board, as recited in claim 6, further comprising a foot brake arrangement which comprises a brake unit, a pivot axle and a spring element, wherein said brake unit includes a L-shaped outer inclined panel for operating said brake unit and a curved inner brake unit having two ends integrally connected with two ends of said outer inclined panel for frictionally biasing against said rear wheel to stop a rotation of said rear wheel, said pivot axle being mounted between said two brake supporting holes formed on said two rear portions of said supporting walls respectively so as to pivotally mount a front end of said brake unit between said two supporting walls, wherein said spring element, which is mounted on said pivot axle, has one end extended to bias against said step board and another end extended to bias against said brake unit, so as to normally support said brake unit to extend right above said rear wheel.

11. The foldable scooter step board, as recited in claim 7, further comprising a foot brake arrangement which comprises a brake unit, a pivot axle and a spring element, wherein said brake unit includes a L-shaped outer inclined panel for operating said brake unit and a curved inner brake unit having two ends integrally connected with two ends of said outer inclined panel for frictionally biasing against said rear wheel to stop a rotation of said rear wheel, said pivot axle being mounted between said two brake supporting holes formed on said two rear portions of said supporting walls respectively so as to pivotally mount a front end of said brake unit between said two supporting walls, wherein said spring element, which is mounted on said pivot axle, has one end extended to bias against said step board and another end extended to bias against said brake unit, so as to normally support said brake unit to extend right above said rear wheel.

12. The foldable scooter step board, as recited in claim 8, further comprising a foot brake arrangement which comprises a brake unit, a pivot axle and a spring element, wherein said brake unit includes a L-shaped outer inclined panel for operating said brake unit and a curved inner brake unit having two ends integrally connected with two ends of said outer inclined panel for frictionally biasing against said rear wheel to stop a rotation of said rear wheel, said pivot axle being mounted between said two brake supporting holes formed on said two rear portions of said supporting walls respectively so as to pivotally mount a front end of said brake unit between said two supporting walls, wherein said spring element, which is mounted on said pivot axle, has one end extended to bias against said step board and another end extended to bias against said brake unit, so as to normally support said brake unit to extend right above said rear wheel.

13. The foldable scooter step board, as recited in claim 1, which is manufactured by the steps of:
(a) forming a step board panel by cutting a predetermined length of an elongated board having a π-shaped cross section, which is made by extrusion to comprise a top panel and said two supporting walls integrally and downwardly extended from a bottom side of said top panel longitudinally;
(b) trimming said step board panel into a predetermined shape wherein four corners of said top panel are curvedly cut to form a board body; and
(c) forming said tail slot by cutting out a portion, positioned between said two supporting walls, of a tail portion of said board body so as to form said wheel chamber between said two supporting walls at said tail portion of said board body.

14. The foldable scooter step board, as recited in claim 13, wherein after the step (c), further comprises a step (d) of forming a pair of wheel holes at two ends of said two supporting walls respectively for rotatably mounting a rear wheel.

15. The foldable scooter step board, as recited in claim 14, wherein after the step (d), further comprises a step (e) of forming two brake supporting holes on said two supporting walls within said wheel chamber respectively.

16. The foldable scooter step board, as recited in claim 15, wherein after the step (e), further comprising a step (f) of pivotally mounting a front end of a brake unit between said two brake supporting holes provided on said tail portion of said board body for braking a rotation of said rear wheel.

17. A process of manufacturing a foldable scooter step board, comprising the steps of:
(a) forming a step board panel by cutting a predetermined length of an elongated board having a π-shaped cross section, which is made by extrusion to comprise a top panel and two parallel supporting walls integrally and downwardly extended from a bottom side of said top panel longitudinally;
(b) trimming said step board panel into a predetermined shape wherein four corners of said top panel are curvedly cut to form a board body; and
(c) forming a tail slot by cutting out a portion, positioned between said two supporting walls, of a tail portion of said board body so as to form a wheel chamber between said two supporting walls at said tail portion of said board body.

18. The process, as recited in claim 17, after the step (c), further comprising a step (d) of forming a pair of wheel holes at two ends of said two supporting walls respectively for rotatably mounting a rear wheel.

19. The process, as recited in claim 18, after the step (d), further comprising a step (e) of forming two brake supporting holes on said two supporting walls within said wheel chamber respectively.

20. The process, as recited in claim 19, after the step (e), further comprising a step (f) of pivotally mounting a front end of a brake unit between said two brake supporting holes provided on said tail portion of said board body for braking a rotation of said rear wheel.
